(19) United States
(12) Patent Application Publication
(10) Pub. No.: US 2019/0319568 A1
(43) Pub. Date: Oct. 17, 2019

(54) LINEAR VIBRATION MOTOR

(71) Applicant: MPLUS CO., LTD., Suwon-si (KR)

(72) Inventors: Yeon Ho SON, Suwon-si (KR); Yong Tae KIM, Suwon-si (KR); Dong Su MOON, Suwon-si (KR)

(21) Appl. No.: 16/367,759

(22) Filed: Mar. 28, 2019

(30) Foreign Application Priority Data
Apr. 11, 2018 (KR) 10-2018-0041873

(51) Int. Cl. H02P 25/032; H02K 33/02

(52) U.S. Cl. CPC H02P 25/032; B06B 1/045; H02K 33/02

(57) ABSTRACT

A linear vibration motor includes a bracket having a center on which a coil is seated, a casing coupled to the bracket and having an internal space formed therein, a stator disposed in the internal space of the casing to generate an electromagnetic force, an oscillator disposed around the stator, an elastic member adapted to vibrate the oscillator, a substrate seating part adapted to seat the casing thereonto, and a substrate having a first area adapted to locate one surface of the bracket thereon, a second area extended from the first area toward a side periphery of the casing, and a third area extended from the second area in such a manner as to be disposed on top of the substrate seating part.

### CROSS REFERENCE TO RELATED APPLICATION

The present application claims priority to Korean Patent Application No. 10-2018-0041873, filed in the Korean Intellectual Property Office on Apr. 11, 2018, the entire content of which is incorporated herein by reference.

### BACKGROUND OF THE INVENTION

### 1. Field of the Invention

The present invention relates to a linear vibration motor, and more particularly, to a linear vibration motor that is capable of generating vibrations in various frequency ranges.

### 2. Description of Related Art

A vibration motor is a part for converting electrical energy into mechanical vibrations through the principle of generation of an electromagnetic force, which is mounted on a portable terminal like a mobile communication terminal.

Currently, the portable terminal like the mobile communication terminal is provided with a touch screen, and if the touch screen is touched, various haptic functions of generating vibrations are provided.

Accordingly, there is a need for development of a vibration motor capable of providing excellent response characteristics and being vibrated in various frequency ranges to perform a variety of haptic functions.

The present invention is derived from the above-mentioned problems to solve the technical problems as mentioned above and to provide additional technical elements that are not easily invented by one of ordinary skill in the art.

### SUMMARY OF THE INVENTION

Accordingly, the present invention has been made in view of the above-mentioned problems occurring in the related art, and it is an object of the present invention to provide a linear vibration motor that is capable of generating vibrations in various frequency ranges.

It is another object of the present invention to provide a linear vibration motor that is capable of converting electrical vibrations into acoustic vibrations, without any separate device, thereby reducing a manufacturing cost and improving space utilization.

The technical problems to be achieved through the present invention are not limited as mentioned above, and other technical problems not mentioned herein will be obviously understood by one of ordinary skill in the art through the following description.

To accomplish the above-mentioned objects, according to one aspect of the present invention, there is provided a linear vibration motor including: a bracket having a center on which a coil is seated; a casing coupled to the bracket and having an internal space formed therein; a stator disposed in the internal space of the casing to generate an electromagnetic force; an oscillator disposed around the stator; an elastic member adapted to vibrate the oscillator; a substrate seating part adapted to seat the casing thereonto; and a substrate having a first area adapted to locate one surface of the bracket thereon, a second area extended from the first area toward a side periphery of the casing, and a third area extended from the second area in such a manner as to be disposed on top of the substrate seating part.

According to the present invention, desirably, the stator includes the coil for generating the electromagnetic force and a coil yoke for amplifying the electromagnetic force.

According to the present invention, desirably, the oscillator includes a magnet for generating vibrations, a weight disposed on the outer periphery of the magnet to amplify the vibrations, and a yoke disposed on the inner periphery of the weight in such a manner as to surround the magnet.

According to the present invention, desirably, the second area is formed along the outer periphery of the casing.

According to the present invention, desirably, the second area is formed along the inner periphery of the casing.

According to the present invention, desirably, the weight has a shape of a ring, and a difference between an outer diameter and an inner diameter of the weight whose portion faces the second area is smaller than a difference between an outer diameter and an inner diameter of the weight whose portion does not face the second area.

According to the present invention, desirably, the casing includes an opening through which the third area is located extendedly from the second area.

According to the present invention, desirably, the substrate seating part and the casing are formed unitarily with each other.

According to the present invention, desirably, the substrate seating part includes input terminals adapted to have power applied from the outside.

To accomplish the above-mentioned objects, according to the other aspect of the present invention, there is provided a linear vibration motor including: a bracket having a center on which a coil is seated; a casing coupled to the bracket and having an internal space formed therein; a stator disposed in the internal space of the casing to generate an electromagnetic force; an oscillator disposed around the stator; an elastic member adapted to vibrate the oscillator; a substrate seating part adapted to seat the casing thereonto; a damper disposed on top of the bracket; and a substrate, wherein the damper is fixed to an edge periphery of the bracket and is empty in the middle portion thereof.

According to the present invention, desirably, the damper has a shape of a ring disposed along the edge periphery of the bracket.

### BRIEF DESCRIPTION OF THE DRAWINGS

The above and other objects, features and advantages of the present invention will be apparent from the following detailed description of one of the embodiments of the invention in conjunction with the accompanying drawings, in which:

FIG. 1 is a perspective view showing a linear vibration motor according to a first embodiment of the present invention;

FIG. 2 is an exploded perspective view showing the linear vibration motor according to the first embodiment of the present invention;

FIG. 3 is a sectional view taken along the line A-A′ of the linear vibration motor according to the first embodiment of the present invention;

FIG. 4 is a perspective view showing the linear vibration motor according to the first embodiment of the present invention, wherein a casing has a square-shaped top;

FIG. 5 is a sectional view showing the linear vibration motor according to the first embodiment of the present invention, wherein an elastic member is placed on the underside of an oscillator;

FIGS. 6A and 6B are sectional views showing the linear vibration motor according to the first embodiment of the present invention so as to explain a substrate;

FIG. 7 is a perspective view showing the linear vibration motor according to the first embodiment of the present invention, wherein a substrate seating part is located on an outer peripheral surface of the casing;

FIG. 8 is a graph showing acceleration to frequencies of the linear vibration motor according to the first embodiment of the present invention;

FIGS. 9A and 9B are sectional views showing the linear vibration motor according to the first embodiment of the present invention, wherein a damper is provided; and

FIG. 10 is a sectional view showing a linear vibration motor according to a second embodiment of the present invention.

### DETAILED DESCRIPTION OF THE INVENTION

Hereinafter, the present invention is in detail explained with reference to the attached drawings.

All terms (including technical or scientific terms) used herein, unless otherwise defined, have the same meanings which are typically understood by those having ordinary skill in the art.

The terminology used herein is for the purpose of describing particular embodiments only and is not intended to be limiting. The term ‘a’ or ‘an’, as used herein, is defined as one or more than one.

In the description, when it is said that one portion is described as “comprises” and “comprising” any component, one element further may include other components unless no specific description is suggested.

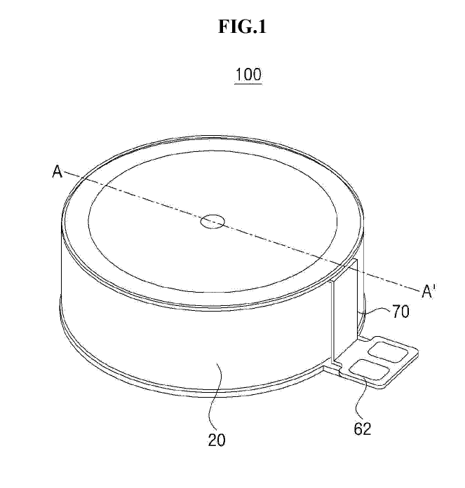

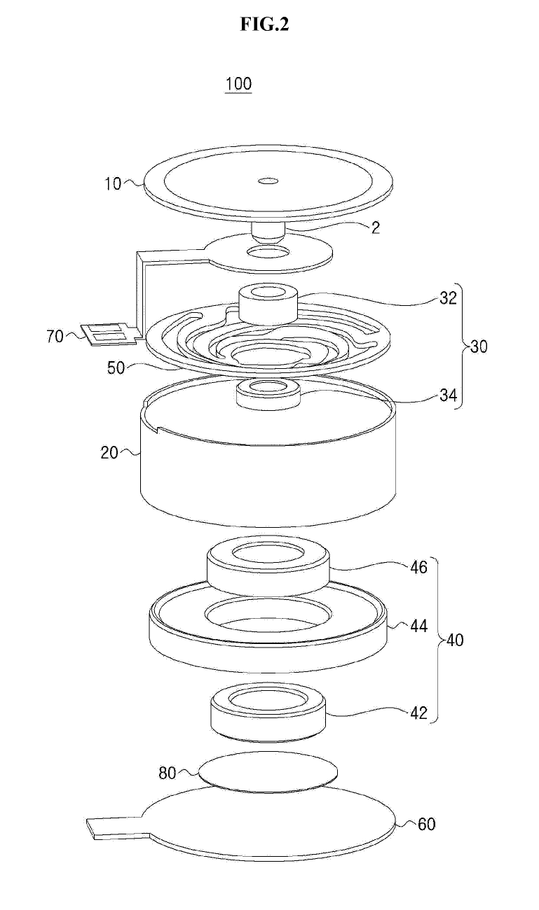

Now, an explanation on a linear vibration motor 100 according to a first embodiment of the present invention will be given with reference to FIGS. 1 to 3. FIG. 1 is a perspective view showing the linear vibration motor 100 according to the first embodiment of the present invention, FIG. 2 is an exploded perspective view showing the linear vibration motor 100 according to the first embodiment of the present invention, and FIG. 3 is a sectional view showing the linear vibration motor 100 according to the first embodiment of the present invention.

The linear vibration motor 100 according to the first embodiment of the present invention includes a bracket 10, a casing 20, a stator 30, an oscillator 40, an elastic member 50, a substrate 70, and a substrate seating part 60.

The bracket 10 has a center on which a coil 32 is seated, and at this time, the bracket 10 is an acoustic diaphragm which is vibrated by means of an electromagnetic force generated from variations of an electrical signal applied to the coil 32 to generate sounds.

Furthermore, the bracket 10 has a coil support 2 protruding from the center thereof, and the coil support 2 is formed on one surface of the bracket 10 in such a manner as to allow the coil 32 to be fitted to the outer periphery thereof.

The coil support 2 is located on the center of one surface of the bracket 10 in such a manner as to protrude downward from the bracket 10 to stably fix the coil 32 thereto.

Furthermore, the coil support 2 may be indented in an inward direction of the bracket 10, that is, inward from the bracket 10 by means of press or dip drawing.

Moreover, the coil support 2 has a hollow portion B, and a thickness of a plate constituting the coil support 2 is equal to or greater than a thickness of the bracket 10.

The casing 20 is coupled to the bracket 10, serves to support the underside surface of the linear vibration motor 100 thereagainst, and has an internal space in which other components of the linear vibration motor 100 are disposed.

At this time, the casing 20 is open on any one of top and bottom thereof.

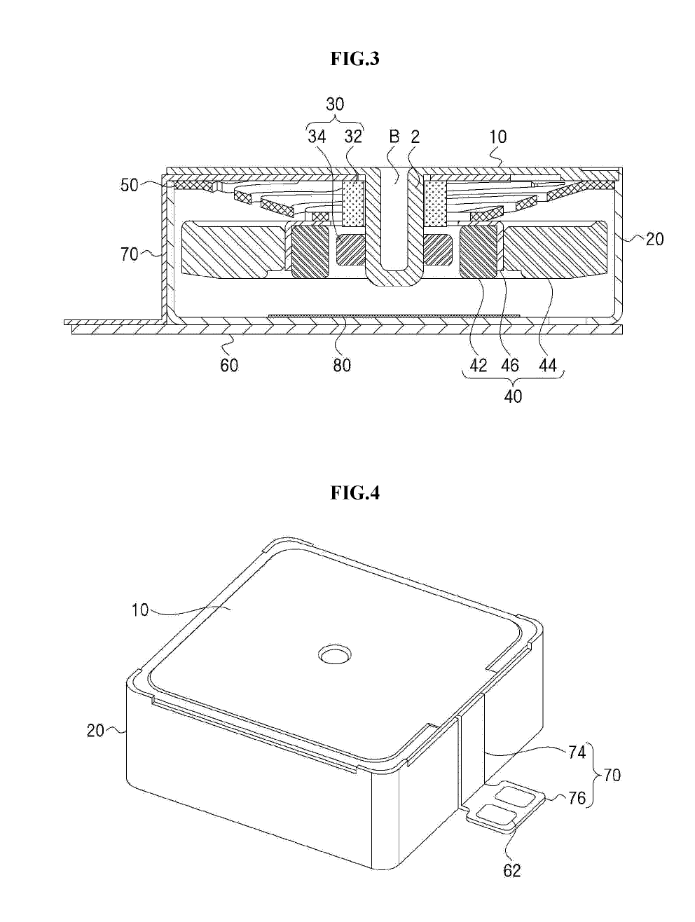

Meanwhile, the casing 20 has a circular top, but it is not necessarily limited thereto. As shown in FIG. 4, for example, the casing 20 has a square top, and otherwise, it may have a polygonal top.

The shape of top of the casing 20 is determined according to a user's design, and a shape of edge periphery of the elastic member 50 is determined according to the shape of top of the casing 20. For example, the casing 20 has the circular, square or polygonal top, and in this case, the elastic member 50 has the shape of edge periphery corresponding to the shape of top of the casing 20.

Referring again to FIGS. 1 to 3, the stator 30 is disposed on the outer peripheral surface of the coil support 2 and includes the coil 32 and a coil yoke 34.

The coil 32 is disposed on the outer peripheral surface of the coil support 2 in such a manner as to come into contact with the substrate 70 and serves to generate an electromagnetic force through the interaction with the oscillator 40. For example, the coil 32 is a sound coil and generates magnetic fields having different directions and strengths therefrom. In more detail, if an alternating current is applied to the coil 32, a force is applied to the coil 32, and through the force, the bracket 10 to which the coil 32 is fitted is vibrated to a signal in an audible frequency range, thereby generating sounds.

Further, a frequency value corresponding to a value of a resonance frequency of the oscillator 40 may be applied to the coil 32. For example, the value of the resonance frequency may be set to the range of 100 to 250 Hz, but it may be changed according to design conditions.

When it is desired that the coil 32 is disposed on the outer peripheral surface of the coil support 2, an adhesive material is additionally applied to the outer peripheral surface of the coil support 2, so that the coil 32 is fixedly attached to the coil support 2.

The coil 32 has a shape of a ring, but it is not limited necessarily thereto.

The coil yoke 34 is spaced apart from the coil 32 in a vertical direction in such a manner as to be disposed on the outer peripheral surface of the coil support 2 and serves to amplify the electromagnetic force generated from the coil 32.

Next, the oscillator 40 is located around the stator 30 and includes a magnet 42, a weight 44, and a yoke 46. If the alternating current is applied to the coil 32, the oscillator 40 is driven according to size variations of the alternating current.

In this case, the magnet 42 is spaced apart from the coil yoke 34 in a horizontal direction in such a manner as to be disposed around the coil yoke 34 and serves to generate vibrations through up and down movements.

Further, the magnet 42 is one, and otherwise, it may include an upper magnet and a lower magnet coupled to each other. If the two magnets are coupled to each other, the electromagnetic force can be stronger than that generated from one magnet.

In addition, a magnetic fluid (not shown) may be applied between the magnet 42 and the coil yoke 34. The application of the magnetic fluid suppresses the vibrating force of the oscillator 40 through the viscosity of the fluid at the time when the vibrations are stopped, thereby achieving noise reduction. Further, the application of the magnetic fluid prevents the coil 32 and the oscillator 40 from coming into direct contact with each other.

The weight 44 is disposed spaced apart from the magnet 42 around the magnet 42 and serves to amplify the vibrations of the oscillator 40. In more detail, the weight 44 is spaced apart from the magnet 42 in the horizontal direction in such a manner as to be disposed around the magnet 42.

Further, the outer peripheral surface of the weight 44 is spaced apart from the inner surface of the bracket 10. When the vibrations are generated, accordingly, the oscillator 40 is prevented from coming into contact with the inner surface of the bracket 10, thereby ensuring reliability of the linear vibration motor 100.

The yoke 46 comes into contact with the inner peripheral surface of the weight 44 in such a manner as to surround the magnet 42 and has an internal space in which the magnet 42 is accommodated. In this case, the yoke 46 serves to allow a magnetic field generated from the magnet 42 to gently flow to form a closed magnetic circuit.

Next, the elastic member 50 has at least a portion of top fixed to one surface of the bracket 10 and a portion of underside coming into contact with the oscillator 40, but it is not limited thereto. The elastic member 50 may have at least a portion of top fixed to one surface of the casing 20.

The elastic member 50 moves the weight 44 by means of elasticity, and through repeated movements of the weight 44, the vibrations can be amplified.

Upon the up and down linear movements of the oscillator 40, further, the elastic member 50 prevents the bracket 10 and the oscillator 40 from colliding against each other, thereby reducing generation of noise.

As shown in FIG. 3, the elastic member 50 is disposed between the coil support 2 and the oscillator 40 on the same plane as the coil 32. Further, the elastic member 50 becomes decreased in width toward the lower portion thereof from the upper portion thereof.

As another example, as shown in FIG. 5, the elastic member 50 is disposed on the underside of the oscillator 40 on the surface opposing to the coil 32. At this time, it can be appreciated that the elastic member 50 becomes increased in width toward the lower portion thereof from the upper portion thereof.

The elastic member 50 is configured to protrude from the center portion thereof, and the yoke 46 is disposed on the center of the elastic member 50 in such a manner as to be connected to the weight 44. For example, if one side of the elastic member 50 comes into contact with the oscillator 40, a plate (not shown) may be disposed to connect the oscillator 40 and the elastic member 50.

Meanwhile, the elastic member 50 is formed of a spring having various shapes and structures. For example, the elastic member 50 is a compression spring or spiral spring.

Further, the elastic member 50 is made of a magnetized metal or a non-magnetic body. The elastic member 50 is bent to provide sufficient elastic and support forces and has incised slots formed thereon.

Referring again to FIGS. 1 to 3, the substrate seating part 60 is configured to allow the casing 20 to be placed thereon in such a manner as to seat the substrate 70 thereon, and at this time, the substrate 70 is fixed to the substrate seating part 60.

Further, the substrate seating part 60 has input terminals 62 whose contact points are exposed to the outside to apply power from the outside thereto. Through the input terminals 62, the substrate 70 seated on the substrate seating part 60 is easily connected to an external substrate (not shown).

According to the first embodiment of the present invention, the linear vibration motor 100 can be attached to another device by means of screws or a double sided tape disposed on the substrate seating part 60.

According to the first embodiment of the present invention, the linear vibration motor 100 further includes a buffering member 80 disposed on the inner bottom of the casing 20.

The buffering member 80 may be disposed on the underside of the casing 20 and serves to release impacts caused by vibrations. The buffering member 80 has a shape of a circular plate, but it is not limited thereto.

The buffering member 80 serves to prevent the oscillator 40 or the elastic member 50 from being damaged or broken due to impacts caused by falls, prevent the oscillator 40 from coming into direct contact with the casing 20 upon the up and down vibrations of the oscillator 40, absorb the impacts caused by the oscillator 40, adjust the vibration force, and prevent the generation of noise by the vibrations.

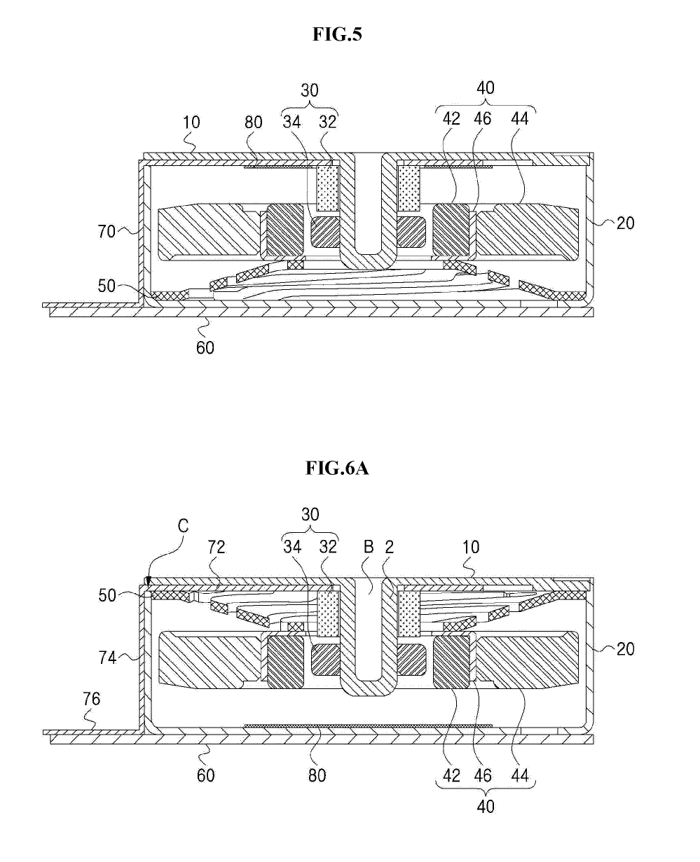

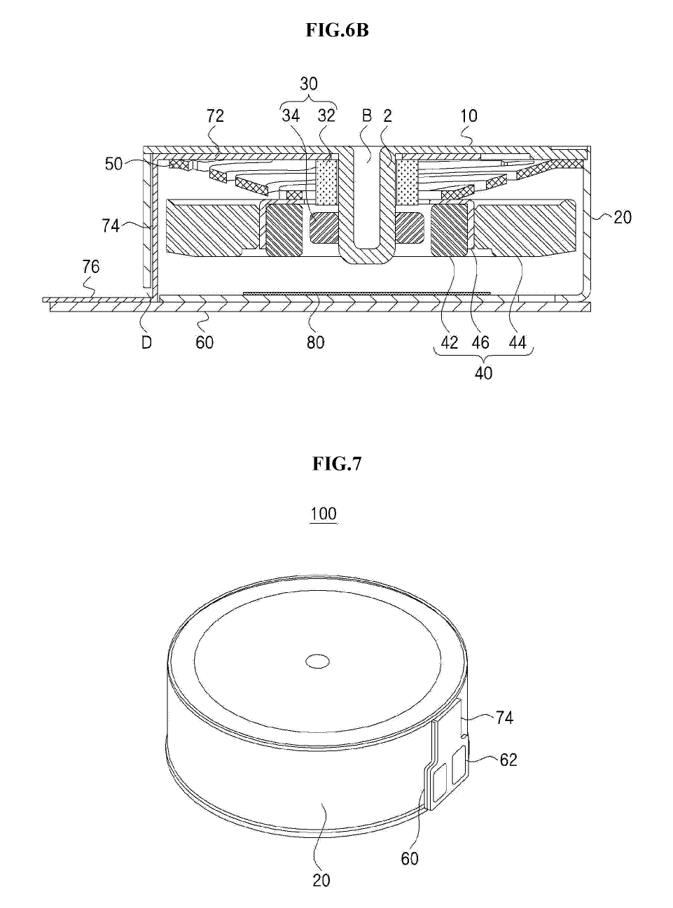

Hereinafter, an explanation on the substrate 70 of the linear vibration motor 100 according to the first embodiment of the present invention will be given with reference to FIGS. 6A and 6B.

FIGS. 6A and 6B are sectional views showing the linear vibration motor 100 according to the first embodiment of the present invention so as to explain the substrate 70.

The substrate 70, to which external power is supplied, is disposed between the bracket 10 and the stator 30. In more detail, the substrate 70 is electrically connected to the coil 32. Further, the substrate 70 is an FPCB, but it is not limited thereto.

So as to allow the substrate 70 to be electrically connected to the external power and the coil 32, the substrate 70 includes a first area 72, a second area 74 and a third area 76.

The first area 72 comes into contact with the inner surface of the bracket 10 and the top of the coil 32, and a portion of the first area 72 comes into contact with the top of the elastic member 50.

The second area 74 is extended from the first area 72 in such a manner as to be placed on the side periphery of the casing 20.

The third area 76 is extended from the second area 74 in such a manner as to be disposed on top of the substrate seating part 60. In more detail, the third area 76 is extendedly disposed in a vertical direction to the second area 74. Further, the third area 76 is disposed on top of the substrate seating part 60 so that it can be connected to the external power.

As shown in FIG. 6A, it can be appreciated that the second area 74 is extended from the first area 72 in such a manner as to be placed on the outer periphery of the casing 20.

If the outer periphery of the casing 20 has a given curvature, the second area 74 also has a given curved surface, and like this, if the second area 74 is curved, it can be rigidly placed on the outer periphery of the casing 20.

Even if the outer periphery of the casing 20 has a given curvature, on the other hand, the second area 74 does not have any curved surface. In this case, even though the second area 74 is not curved, it can be stably fixed to the top of the substrate seating part 60 through the third area 76.

When the second area 74 is disposed on the outer periphery of the casing 20, an opening C is formed between the casing 20 and the bracket 10 so as to allow the second area 74 to be extended from the first area 72.

As shown in FIG. 7, it can be appreciated that when the second area 74 is formed along the outer periphery of the casing 20, the substrate seating part 60 is also disposed on the outer periphery of the casing 20 corresponding to the second area 74.

In more detail, if the substrate seating part 60 is also disposed on the outer periphery of the casing 20, the substrate 70 does not need to have the third area 76.

Unlike FIG. 6A, on the other hand, FIG. 6B shows that the second area 74 is extended from the first area 72 in such a manner as to be located on the inner periphery of the casing 20.

If the inner periphery of the casing 20 has a given curvature, the second area 74 also has a given curved surface, and like this, if the second area 74 is curved, it can be rigidly placed on the inner periphery of the casing 20.

Even if the inner periphery of the casing 20 has a given curvature, on the other hand, the second area 74 does not have any curved surface. In this case, even though the second area 74 is not curved, it can be stably fixed to the top of the substrate seating part 60 through the third area 76.

When the second area 74 is located on the inner periphery of the casing 20, a difference between an outer diameter and an inner diameter of the weight 44 whose portion faces the second area 74 is smaller than a difference between an outer diameter and an inner diameter of the weight 44 whose portion does not face the second area 74. When seen on the sectional view of FIG. 6B, that is, a portion of the weight 44 which is close to the second area 74 is formed shorter than a portion of the weight 44 which is distant from the second area 74.

Since the difference between the outer diameter and the inner diameter of the weight 44 whose portion faces the second area 74 is smaller than the difference between the outer diameter and the inner diameter of the weight 44 whose portion does not face the second area 74, accordingly, the substrate 70 does not inhibit the movements of the weight 44 and is prevented from coming into contact with the weight 44. So as to allow the difference between the outer diameter and the inner diameter of the weight 44 whose portion faces the second area 74 to be smaller than the difference between the outer diameter and the inner diameter of the weight 44 whose portion does not face the second area 74, a portion of the weight 44 is cut off, or an escape groove is formed. In this case, the escape groove is formed in consideration of the width and thickness of the substrate 70.

Further, the third area 76 is extended from the second area 74, and the casing 20 has an opening D through which the third area 76 is located extendedly from the second area.

FIG. 8 is a graph showing acceleration to frequencies of the linear vibration motor 100 according to the first embodiment of the present invention. In detail, FIG. 8 shows that acceleration values to vibration data of the linear vibration motor 100 generated in various frequency ranges are collected through an acceleration sensor.

As shown in FIG. 8, it can be appreciated that the linear vibration motor 100 according to the first embodiment of the present invention generates vibrations at a high frequency. In more detail, the linear vibration motor 100 according to the first embodiment of the present invention is driven even in a frequency range of 5,000 Hz or more to generate vibrations. Like this, the linear vibration motor 100 according to the first embodiment of the present invention can generate vibrations even in a high frequency range, thereby performing more various haptic functions.

If the linear vibration motor 100 according to the first embodiment of the present invention is applied to a cellular phone, it generates vibrations from the surface of a display of the cellular phone, and further, it generates sounds from the surface of the display, without using any receiver on the front surface of the cellular phone, thereby improving space utilization of a display screen.

There is no need to machine a portion of the display from which sounds are outputted, further, thereby lowering a manufacturing cost of the cellular phone.

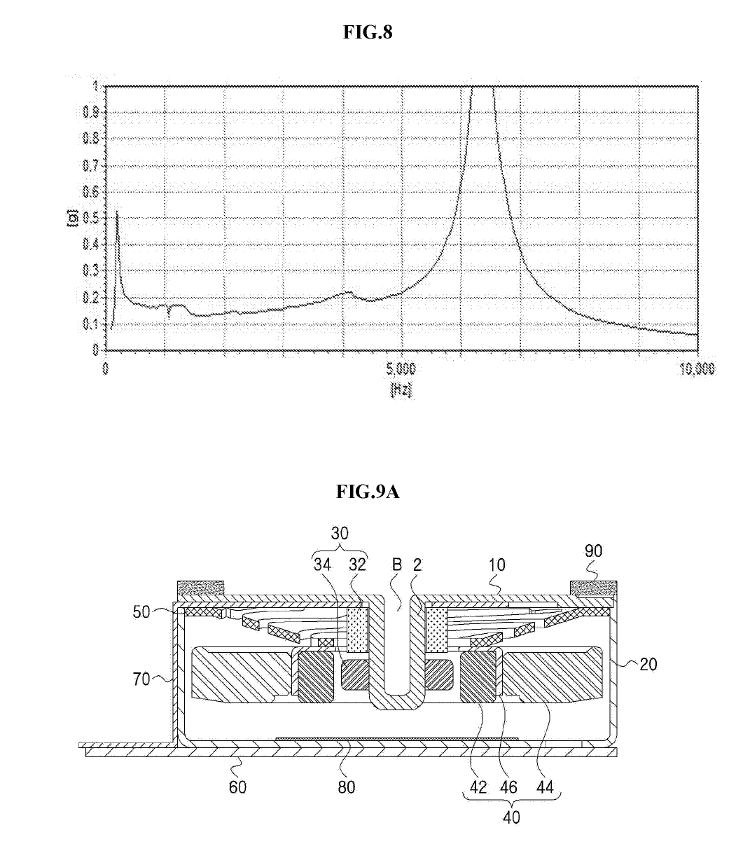

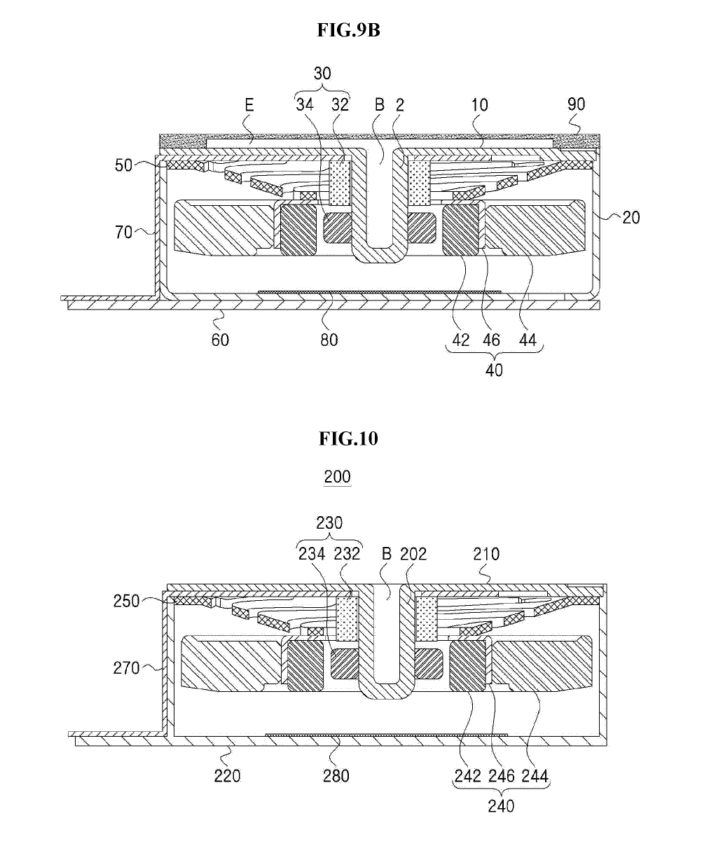

As shown in FIGS. 9A and 9B, in addition, the linear vibration motor 100 according to the first embodiment of the present invention further includes a damper 90 disposed on top of the bracket 10.

FIGS. 9A and 9B are sectional views showing the linear vibration motor 100 according to the first embodiment of the present invention, wherein the damper 90 is provided.

As shown in FIG. 9A, the damper 90 is disposed on top of the bracket 10 along the edge periphery of the bracket 10.

As the damper 90 is fixedly to top of the bracket 10 along the edge periphery of the bracket 10, a space is formed in the internal area in which the coil 32 is disposed, so that at the time when the vibrations are generated, decrement in the vibrating forces caused by the damper 90 can be prevented.

As shown in FIG. 9B, meanwhile, the damper 90 has a shape of a ring whose top is closed.

If the damper 90 is formed of the ring whose top is closed, a middle portion thereof is empty to form a space to which vibrations are transferred, thereby ensuring the vibration force of the linear vibration motor 100.

Hereinafter, a linear vibration motor 200 according to a second embodiment of the present invention will be explained with reference to FIG. 10.

FIG. 10 is a sectional view showing the linear vibration motor 200 according to the second embodiment of the present invention.

The linear vibration motor 200 according to the second embodiment of the present invention is characterized in that the substrate seating part 60 in the first embodiment of the present invention is formed unitarily with one surface (underside) of the casing 20 in the first embodiment of the present invention, and it includes a first bracket 210, a second bracket 220, a stator 230, an oscillator 240 and an elastic member 250.

A detailed explanation on the corresponding parts to those in FIGS. 1 to 9B will be avoided for the brevity of the description.

The first bracket 210 has a coil support 202 disposed at the center thereof, and the coil support 202 is formed on one surface of the first bracket 210 in such a manner as to allow a coil 232 to be fitted to the outer periphery thereof.

The coil support 202 is located on the center of one surface of the first bracket 210 in such a manner as to protrude inward from the first bracket 210 to stably fix the coil 232 thereto.

Furthermore, the coil support 202 may be indented in an inward direction of the first bracket 210, that is, inward from the first bracket 210 by means of press or dip drawing.

Moreover, the coil support 202 has a hollow portion B, and a thickness of a plate constituting the coil support 202 is equal to or greater than a thickness of the first bracket 210.

Meanwhile, the first bracket 210 has a circular or polygonal top. According to the second embodiment of the present invention, the first bracket 210 has a circular top, but it is not necessarily limited thereto. For example, the first bracket 210 has a polygonal top. The shape of top of the first bracket 210 is determined according to a user's design, and a shape of edge periphery of the elastic member 250 is determined according to the shape of top of the first bracket 210. For example, the first bracket 210 has the polygonal top, and in this case, the elastic member 250 has the polygonal top corresponding to the shape of top of the first bracket 210.

Further, the first bracket 210 may have a shape of a cylinder whose top and bottom are open.

Next, the second bracket 220 is coupled to the first bracket 210 to support the underside of the linear vibration motor 200 thereagainst and has an internal space in which other components of the linear vibration motor 200 are disposed.

The installation of the second bracket 220 enables the substrate seating part 60 in the first embodiment of the present invention to be omitted, thereby reducing the whole thickness of the linear vibration motor 200. In more detail, the second bracket 220 is provided to allow the substrate seating part 60 in the first embodiment of the present invention to be formed unitarily with one surface (underside) of the casing 20 in the first embodiment of the present invention.

The configurations of the stator 230, the oscillator 240, the elastic member 250 and the substrate 270 according to the second embodiment of the present invention are the same as those of the stator 30, the oscillator 40, the elastic member 50 and the substrate 70 according to the first embodiment of the present invention, and therefore, detailed explanations on them will be avoided for the brevity of the description.

The linear vibration motor 200 according to the second embodiment of the present invention can solve limitations in size, thereby improving space utilization thereof. Further, the linear vibration motor 200 according to the second embodiment of the present invention can be reduced in the whole thickness thereof, while maintaining stable operating characteristics.

An electronic device, to which the linear vibration motor according to the embodiments of the present invention is applied, includes at least one of a smartphone, a tablet personal computer, a mobile phone, a video phone, an e-book reader, a desktop personal computer, a laptop personal computer, a netbook computer, a workstation, a server, a personal digital assistant (PDA), a portable multimedia player (PMP), an MP3 player, a mobile medicine machine, a camera, and a wearable device. According to various embodiments of the present invention, the wearable device includes at least one of an accessory type device such as a watch, a ring, a bracelet, an anklet, a necklace, glasses, and a contact lens, a head-mounted device (HMD), a textile or cloth integral type device (e.g., electronic garment), a body attaching type device (e.g., skin pad or tattoo), and a body-implant type device (e.g., an implantable circuit).

According to various embodiments of the present invention, the electronic device is a home appliance. For example, the home appliance includes at least one of a television, a digital video disk (DVD) player, an audio, a refrigerator, an air conditioner, a cleaner, an oven, a microwave oven, a washing machine, an air purifier, a set-top box, a home automation control panel, a security control panel, a TV box (e.g., HomeSync™, appleTV™, or GoogleTV™), a game console (e.g., Xbox™ or PlayStation™), an electronic dictionary, an electronic key, a camcorder, and an electronic picture frame.

According to various embodiments of the present invention, the electronic device includes at least one of all kinds of medical equipment such as various portable medical monitors like a blood glucose monitor, a heart rate monitor, a blood pressure monitor, and a blood temperature monitor, magnetic resonance angiography (MRA), magnetic resonance imaging (MRI), computed tomography (CT), an imaging system, and an ultrasonic device, a navigation device, a global navigation satellite system (GNSS), an event data recorder (EDR), a flight data recorder (FDR), a car infotainment device, electronic equipment for a ship (e.g., a navigation system for a ship, a gyrocompass, and so on), avionics, security equipment, a car head unit, an industrial or home robot, an automatic teller's machine (ATM) of financial institutions, point of sales (POS) of shops, and internet of things (e.g., a light bulb, a sensor, an electric or gas meter, a sprinkler, a fire alarm device, a thermostat, a street lamp, a toaster, an exercise machine, a hot water tank, a heater, a boiler, and so on).

According to various embodiments of the present invention, further, the electronic device includes at least one of a portion of furniture or building/structure, an electronic board, an electronic signature receiving device, a projector, and various meters (e.g., water, electricity, gas, and electromagnetic wave meters). According to various embodiments of the present invention, further, the electronic device is one or the above-mentioned various devices or a combination of them. According to the present invention, the electronic device may be a flexible electronic device. Further, the electronic device according to the embodiments of the present invention is not limited to the above-mentioned devices, and further, it may include new electronic devices through the development of technologies.

As described above, the linear vibration motor according to the present invention can generate vibrations in various frequency ranges.

In addition, the linear vibration motor according to the present invention can convert electrical vibrations into acoustic vibrations, without any separate device, thereby reducing a manufacturing cost and improving space utilization.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A linear vibration motor comprising:
a bracket having a center on which a coil is seated;
a casing coupled to the bracket and having an internal space formed therein;
a stator disposed in the internal space of the casing to generate an electromagnetic force;
an oscillator disposed around the stator;
an elastic member adapted to vibrate the oscillator;
a substrate seating part adapted to seat the casing thereonto; and
a substrate having a first area adapted to locate one surface of the bracket thereon and a second area extended from the first area toward a side periphery of the casing.

2. The linear vibration motor according to claim 1, wherein the substrate further comprises a third area extended from the second area in such a manner as to be disposed on top of the substrate seating part.

3. The linear vibration motor according to claim 1, wherein:
the stator comprises the coil for generating the electromagnetic force and a coil yoke for amplifying the electromagnetic force, and
the oscillator comprises a magnet for generating vibrations, a weight disposed on the outer periphery of the magnet to amplify the vibrations, and a yoke disposed on the inner periphery of the weight in such a manner as to surround the magnet.

4. The linear vibration motor according to claim 1, wherein the second area is formed along the outer periphery of the casing.

5. The linear vibration motor according to claim 1, wherein the second area is formed along the inner periphery of the casing.

6. The linear vibration motor according to claim 1, wherein the weight has a shape of a ring, and a difference between an outer diameter and an inner diameter of the weight whose portion faces the second area is smaller than a difference between an outer diameter and an inner diameter of the weight whose portion does not face the second area.

7. The linear vibration motor according to claim 2, wherein the casing comprises an opening through which the third area is located extendedly from the second area.

8. The linear vibration motor according to claim 1, wherein the substrate seating part and the casing are formed unitarily with each other.

9. The linear vibration motor according to claim 1, wherein the substrate seating part comprises input terminals adapted to have power applied from the outside.

10. A linear vibration motor comprising:
a bracket having a center on which a coil is seated;
a casing coupled to the bracket and having an internal space formed therein;
a stator disposed in the internal space of the casing to generate an electromagnetic force;
an oscillator disposed around the stator;
an elastic member adapted to vibrate the oscillator;
a substrate seating part adapted to seat the casing thereonto;
a damper disposed on top of the bracket; and
a substrate,
wherein the damper has a shape of a ring disposed along an edge periphery of the bracket.

11. The linear vibration motor according to claim 10, wherein the damper has a shape of the ring whose top is closed and whose middle portion is empty.
